(19) United States
(12) Patent Application Publication
(10) Pub. No.: US 2026/0348385 A1
(43) Pub. Date: Nov. 5, 2026

(54) VACUUM PUMP

(71) Applicant: Leybold Frances SAS, Bourg-Lès-Valence (FR)

(72) Inventors: Christian Moulin, Bourg-Lès-Valence (FR); Augustin Goure, Bourg-Lès-Valence (FR); Frederic Piu, Bourg-Lès-Valence (FR); Mickael Serayet, Bourg-Lès-Valence (FR); Christophe Despesse, Bourg-Lès-Valence (FR)

(21) Appl. No.: 19/484,202

(22) PCT Filed: May 13, 2024
(86) PCT No.: PCT/EP2024/063105

§ 371 Date: Nov. 13, 2025

(30) Foreign Application Priority Data
May 15, 2023 (EP) 23305763.7

(51) Int. Cl. F04C 29/12; F04C 18/344; F04C 25/02

(52) U.S. Cl. CPC F04C 29/126; F04C 25/02; F04C 18/344; F04C 2220/10; F04C 2250/101; F05C 2225/00

(57) ABSTRACT

The application describes a rotary vane vacuum pump, comprising a stator and an inlet portion together defining an outer surface of a chamber, the outer surface of the chamber comprising an inlet for admitting gas to be pumped and an outlet for exhausting gas. The vacuum pump further comprises a rotor housed within the chamber and configured to cooperate with the stator and the inlet portion during operation of the vacuum pump to pump gas from the inlet to the outlet. The inlet portion is mounted within an inlet channel of the vacuum pump and defines at least a portion of the inlet. A surface of the inlet portion facing the chamber forms a portion of the outer surface of the chamber.

### CROSS-REFERENCE TO RELATED APPLICATION

This application is a Section 371 National Stage Application of International Application No. PCT/EP2024/063105 filed May 13, 2024, and published as WO2024/235915 A1 on Nov. 21, 2024, the content of which is hereby incorporated by reference in its entirety and which claims priority of European Application No. 23305763.7, filed May 15, 2023.

### FIELD

The field of the invention relates to a rotary vane vacuum pump.

### BACKGROUND

Rotary vane vacuum pumps typically comprise: a stator defining a chamber having an inlet and an outlet; and a rotor housed within the chamber and configured to cooperate with the stator to pump fluid from the inlet to the outlet. Known stators are made from a single metal structure which can be heavy, expensive, and difficult to form.

Some vacuum pumps comprise inlet valves configured to inhibit fluid back flow towards the enclosure to be evacuated when the pump is not active. Typically, at least a portion of the inlet valve is integrally formed with the stator which can increase the complexity of the stator. As a result, the stator can be difficult to make and, in particular, difficult to cast from metal.

It would be desirable to address one or more of the above-mentioned drawbacks associated with known rotary vane vacuum pumps.

The discussion above is merely provided for general background information and is not intended to be used as an aid in determining the scope of the claimed subject matter. The claimed subject matter is not limited to implementations that solve any or all disadvantages noted in the background.

### SUMMARY

According to a first aspect of the invention, there is provided a rotary vane vacuum pump, comprising: a stator and an inlet portion together defining an outer surface of a chamber, said outer surface of said chamber comprising an inlet for admitting gas to be pumped and an outlet for exhausting gas; and a rotor housed within the chamber and configured to cooperate with the stator and the inlet portion during operation of the vacuum pump to pump gas from the inlet to the outlet, wherein the inlet portion is mounted within an inlet channel of the vacuum pump and defines at least a portion of the inlet, and wherein a surface of the inlet portion facing the chamber forms a portion of the outer surface of the chamber.

In this arrangement, the chamber is formed by a separate stator and inlet portion. This allows the chamber to be made in parts which are later assembled to form the chamber. Manufacturing these components separately may facilitate manufacture of the chamber, particularly where complex structures are required such as an integrated inlet valve. It may further allow the inlet portion to be made from a different material to the stator. For example, the inlet portion may be formed from a material that is more workable than the stator material to facilitate manufacture of an inlet valve. Additionally or alternatively, the inlet portion can be formed by a material that is lighter and/or cheaper to provide a weight and/or cost saving. Note that the chamber is still required to withstand the stresses exerted by the rotor during operation of the pump and so only a portion of the chamber adjacent the inlet is formed separately to the rest of the stator.

In some embodiments, the inlet portion is made from a plastics material.

Conventional stators are made from metal because it is robust enough to withstand the stresses and temperatures experienced by the stator during operation of the vacuum pump. Notably, the rotor blades exert frictional forces on the stator whilst rotating at high speeds as they capture, transport and compress gas from the inlet and exhaust it at the outlet. Forces experienced around and in particular, upstream of the inlet to the chamber are reduced because the compressed gas has been exhausted and the inlet gas is yet to be captured. It is acceptable and indeed may be advantageous here, for the rotor blades not to contact the stator. Accordingly, it may be acceptable for the inlet portion to be formed from plastic while maintaining sufficient structural integrity of the vacuum pump for normal operation. By replacing a part of the metal stator with a plastic inlet portion, a cost saving and a weight saving can be obtained. Moreover, manufacturing in plastic is often simpler than with metal. In this way, the present arrangement can facilitate manufacture of intricate inlet structures such as inlet valves.

In some embodiments, the inlet portion comprises a valve support and the vacuum pump comprises a valve member supported by the valve support, the valve member being movable between an open position permitting gas flow through the inlet channel and a closed position inhibiting gas flow through the inlet channel.

Manufacture of a conventional stator with integrated inlet valve is more complex than without an inlet valve because the stator may need to be formed with a valve support configured to support a valve member and, in some embodiments, a gas channel for conveying gas to selectively activate the valve member. Forming these structures via metal casting can be difficult if an additional core is required during the casting process. As discussed above, the inlet portion is separate to the stator and therefore could be made from a more workable material to facilitate manufacture of the components of the inlet valve. For example, the inlet portion can be formed from plastic which can simplify the manufacture of the valve support because plastic is more versatile than metal and can be used to form complex structures more readily. This can lead to a cost saving.

In some embodiments, the vacuum pump comprises an inlet cover at least partly defining the inlet channel, wherein the inlet cover comprises a valve seat, wherein the valve member, in the closed position, is configured to seal against the valve seat. Forming the valve seat using the inlet cover can obviate the need for additional components to make the inlet valve.

In some embodiments, the inlet cover is formed from metal. In this way, the inlet cover can withstand stress that may be transferred from the pumping mechanism during operation of the vacuum pump.

In some embodiments, the inlet cover comprises: an upstream portion configured for coupling to an enclosure to be evacuated; and a downstream portion for connection to the stator; wherein a portion of the inlet channel defined by the upstream portion and a portion of the inlet channel defined by the downstream portion are offset with respect to each other to form a kinked inlet channel; wherein the inlet cover further comprises a protrusion extending into the inlet channel and configured to impede fluid from travelling from the chamber through the inlet channel towards the upstream portion of the inlet cover. The kinked inlet channel and the protrusion cooperate to impede liquid, for example, lubricant oil, that can be projected up the inlet channel by the rotor during operation of the vacuum pump. In this way, liquid flowing up the inlet channel that might contaminate the enclosure being evacuated can be obstructed. Accordingly, contamination by the vacuum pump of the enclosure being evacuated can be reduced or eliminated.

In some embodiments, the protrusion is arranged to deflect liquid travelling towards the valve member back towards the chamber. In this way, the protrusion may impede the flow of liquid, such as lubricating oil, expelled from the chamber by the rotor vanes and protect the inlet valve from liquid which could damage the inlet valve or reduce its effectiveness.

In some embodiments, the valve member comprises an O-ring for sealing against the valve seat. An O-ring provides a simple, cost effective and reliable seal that may effectively inhibit fluid backflow through the valve.

In some embodiments, the valve member is formed from a plastics material. Providing a plastic valve member can provide additional cost and weight savings compared to a metal inlet valve member.

In some embodiments, the inlet portion comprises a gas channel for conveying gas to selectively actuate the valve member from the open position to the closed position. Where the valve is one configured to be actuated by gas flow in a gas channel then such an arrangement may be particularly complex to form in metal. In this regard, casting such a gas channel in metal is both difficult and expensive because an additional core is required for the casting process. However, by forming the gas channel within the inlet portion which is separate to the stator, the manufacture of the gas channel is simplified because the inlet portion can be made separately to the stator and later assembled. Forming the gas channel can be particularly easy if the inlet portion is formed from plastic.

In some embodiments, the inlet cover and the inlet portion are arranged such that, during operation of the vacuum pump, gas flows through the inlet channel, around the inlet portion and into the chamber.

In some embodiments, the portion of the outer surface of the chamber defined by the stator is made of metal. In this way, the stator can withstand the forces experienced during operation of the vacuum pump.

In some embodiments, the surface of the inlet portion facing the chamber is curved. The surface of the chamber is curved and the ends of the rotor blades or vanes follow a curved trajectory. Therefore, providing the inlet portion with a curved surface may allow the inlet portion to have a minimal or at least reduced effect on the pumping action.

In some embodiments, a curvature of the surface matches a curvature of the portion of the outer surface of the chamber defined by the stator. In this way, the inlet portion and the stator substantially replicate the chambers of conventional rotary vane vacuum pumps formed by a single metal stator element.

In some embodiments, the inlet portion is mounted such that the rotor does not contact the surface of the inlet portion facing the chamber during operation of the vacuum pump.

Rotor vanes of conventional rotor-vane vacuum pumps may not be configured to contact a portion of the stator immediately adjacent to the inlet of the chamber that is after the exhaust but before the rotor vanes pass the inlet. Some rotary vane vacuum pumps are configured like this to increase the size of the pumped volumes defined between the rotor vanes and the stator and conveying from the inlet to the outlet during operation of the vacuum pump. In this embodiment, the inlet portion is arranged to replace the section of such a conventional stator which would not be contacted by the rotor during operation of the pump. As a result, the inlet portion experiences reduced stress during operation of the pump compared to the rest of the chamber which is formed by the stator. This may allow the inlet portion to be made of lighter and cheaper materials, such as plastic, which might be less robust than typical metals used for conventional stators, whilst maintaining sufficient structural integrity for the vacuum pump to operate.

In some embodiments, the surface of the inlet portion defines at least 5%, preferably at least 10%, of a circumference of a cross-section of the outer surface of the chamber. In some embodiments, the surface if the inlet portion extends at least 35 degrees, preferably about 40 degrees, of a circumference of a cross-section of the outer surface of the chamber. The larger the proportion of the chamber defined by the inlet portion the larger the potential cost and weight savings.

In some embodiments, the vacuum pump comprises an oil-sealed vacuum pump.

According to a second aspect of the invention, there is provided a method of replacing an inlet valve of a rotary vane vacuum pump according to a first aspect, comprising at least one of the following: removing an inlet portion from the rotary vane vacuum pump and inserting a replacement inlet portion; and removing a valve member from the rotary vane vacuum pump of the first aspect and inserting a replacement valve member.

The arrangement of the inlet portion which may comprise an inlet valve as a separate component to the stator allows it to be replaced. In this regard, making them as separate components allows them to be formed of a different material to the stator which may be less robust, such that they may wear out before the stator does. Furthermore. a valve has a movable part and as such may be prone to wear. Thus, being able to replace such parts can be advantageous.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The summary is provided to introduce a selection of concepts in a simplified form that are further described in the detailed description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIG. 1 shows a section through a vacuum pump according to an embodiment;

FIG. 2 shows an exploded view of the embodiment of FIG. 1;

FIG. 3 shows a section through an inlet portion of a vacuum pump according to another embodiment; and

FIG. 4 shows a flow chart illustrating steps in a method according to an embodiment.

### DETAILED DESCRIPTION

Before discussing the embodiments in any more detail, first an overview will be provided.

Embodiments relate to a rotary vane vacuum pump comprising a chamber defined by a stator and an inlet portion. The chamber comprises an inlet and an outlet and houses a rotor configured to cooperate with the stator and inlet portion to pump fluid from the inlet to the outlet. The inlet portion forms at least a part of the inlet and may form a portion of a surface of the chamber adjacent to and upstream of the inlet. It is acceptable and indeed may be advantageous here, for the rotor blades not to contact the chamber surface and as such this portion of the chamber surface may be formed from a lighter, cheaper and more workable material than the metals used for conventional stators. For example, the inlet portion may be made from a plastics material. Furthermore, forming the inlet portion from plastic can facilitate the manufacture of more intricate structures such as a valve support and a gas channel for an inlet valve. Accordingly, embodiments can provide a rotary vane vacuum pump that is lighter and easier to manufacture than some conventional vacuum pumps.

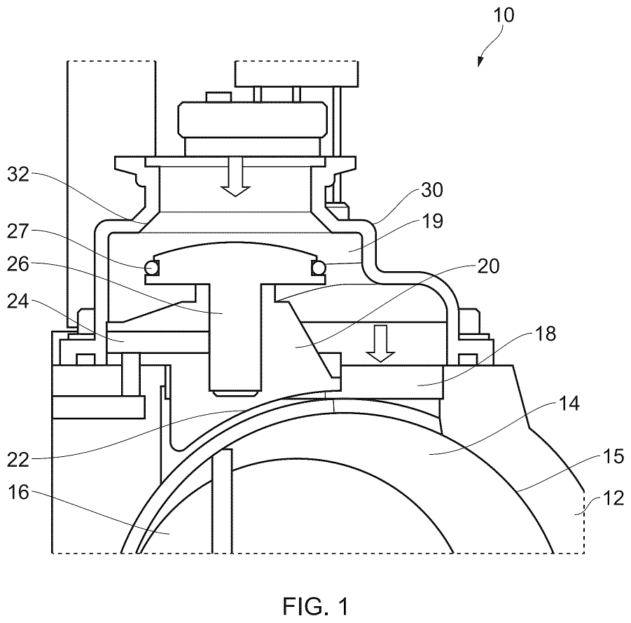

FIG. 1 shows a portion of a vacuum pump 10 comprising a stator 12 which, together with an inlet portion 20, defines a chamber 14. The outer surface 15 of the chamber 14 comprises a surface 22 of the inlet portion 20 which faces the chamber 14. The remainder of the outer surface 15 is provided by the stator 12. A rotor 16 is housed within the chamber 14 and is configured to cooperate with the stator 12 and inlet portion 20 to pump fluid from an inlet 18 of the chamber 14 to an outlet (not shown) of the chamber 14. The pumping mechanism is a rotary vane pumping mechanism as known in the art. The inlet 18 of the chamber 14 is at least partly formed by the inlet portion 20. The inlet portion 20 and the rotor 16 are configured such that the rotor 16 does not contact the inlet portion 20 during operation of the vacuum pump 10.

The vacuum pump 10 further comprises an inlet cover 30 which at least partly defines an inlet channel 19 for introducing gas into the chamber 14 via the inlet 18. The inlet cover 30 is configured to connect to an enclosure to be evacuated. The flow of fluid through the inlet channel 30 during operation of the vacuum pump 10 is shown by the arrows in FIG. 1. Fluid is drawn by the pumping mechanism through the inlet channel 19, around the inlet portion 20 and into the chamber 14.

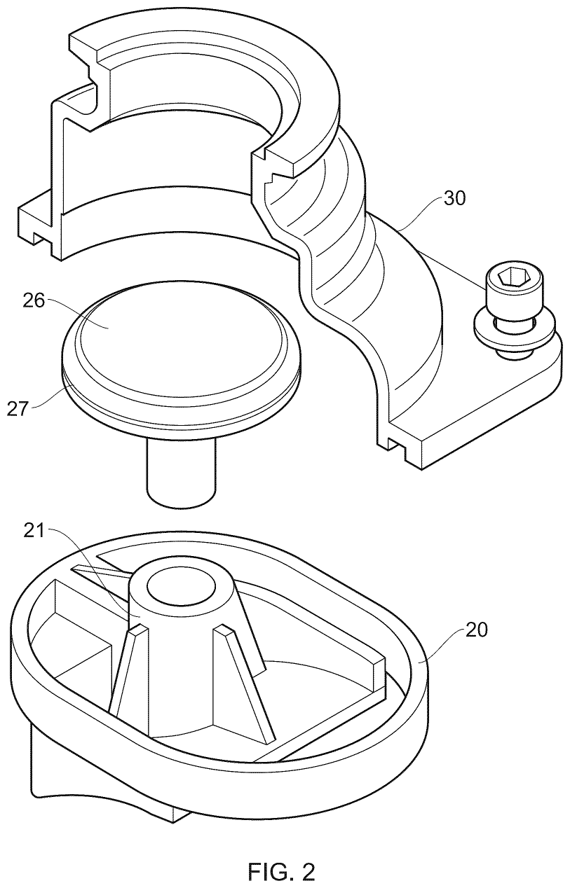

An inlet valve is positioned within the inlet channel 19 for selectively inhibiting fluid flow through the inlet channel 19. The inlet valve comprises a valve member 26 supported by a valve support 21 (see FIG. 2) defined by the inlet portion 20. The valve member 26 is moveable between an open position (shown in FIG. 1) for permitting fluid flow through the inlet channel 19 and a closed position (not shown) for inhibiting fluid flow up through the inlet channel 19. The valve member 19 is actuated by gas that can be selectively introduced via gas channel 24 defined in the inlet portion 20. In the closed position, the valve member 26 is configured to seal against a valve seat 32 defined by the inlet cover 30. The valve member 26 supports an O-ring 27 to provide the seal. It will be appreciated that other types of inlet valves may be used to inhibit undesirable backflow such as an electric actuated valve.

The inlet portion 20 is formed from plastic. The stator 12 which forms the remainder of the outer surface 15 is made from metal. The inlet portion 20 and the rotor 16 are arranged such that the surface 22 forming a portion of the outer surface 15 of the chamber 14 is not contacted by the rotor 16 during operation of the vacuum pump 10. This reduces the likelihood of damaging the plastic inlet portion 20 which might be less robust that the metal stator 12. Furthermore, by providing a plastic inlet portion 20 that is separate to the metal stator 15, embodiments can provide a cost and weight saving compared to conventional metal stators. Additionally, manufacturing of the vacuum pump may be simplified because components, such as the valve support 21 and gas channel 24, may require an additional core if made by casting metal. Such components can readily be formed from plastic.

FIG. 2 shows an exploded view of the inlet portion 20 including the valve support 21, the inlet cover 30, and the valve member 26 including the O-ring 27.

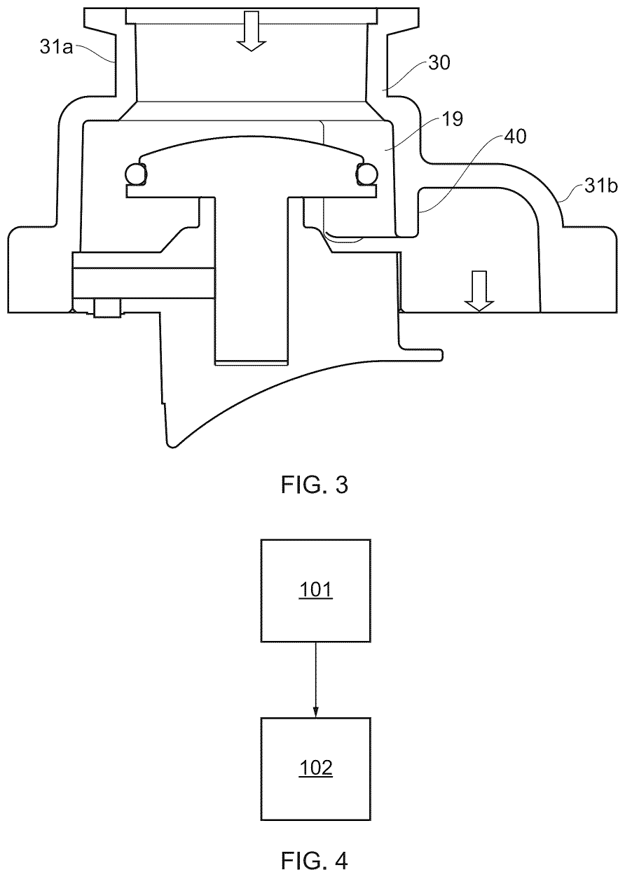

FIG. 3 shows another embodiment which is substantially the same as the embodiment shown in FIG. 1 with the exception that the inlet cover comprises a protrusion 40. The inlet cover 30 comprises an upstream portion 31a configured for coupling to an enclosure to be evacuated and a downstream portion for connection to the stator (the stator has been omitted from FIG. 3 for simplicity but is similar to the stator shown in FIG. 1). A portion of the inlet channel 19 defined by the upstream portion 31a and a portion of the inlet channel 19 defined by the downstream portion 31b are offset with respect to each other to form a kinked inlet channel. During operation of the vacuum pump, the rotor may fling liquid, such as lubricating oil, out of the chamber and up the inlet channel. The kink in the inlet channel impedes liquid flowing from the pumping mechanism up the inlet channel 19 towards the upstream portion 31a because there is no straight path for the liquid to follow.

The protrusion 40 extends from the inlet cover 30 and into the inlet channel 19 such that it can impede liquid travelling towards the upstream portion 31a towards the inlet valve from the chamber. This can reduce or eliminate contamination of the enclosure being evacuated by the vacuum pump by such liquid. The protrusion 40 extends from a portion of the inlet cover 30 between the upstream portion 31a and the downstream portion 31b. The protrusion 40 is arranged to deflect liquid travelling towards the valve member back towards the chamber. In this way, any liquid such as oil that is projected from the chamber by the rotor can be impeded from contacting the valve member, thereby reducing the chances of such liquid damaging the valve member or reducing its effectiveness.

FIG. 4 shows a flowchart of a method according to an embodiment. The method comprises replacing an inlet valve of a rotary vane vacuum pump according to an embodiment. Step 101 includes removing an inlet portion from the rotary vane vacuum pump and/or removing a valve member from the rotary vane vacuum pump. Step 102 includes inserting a replacement inlet portion and/or inserting a replacement valve member, respectively.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A rotary vane vacuum pump, comprising:
a stator and an inlet portion together defining an outer surface of a chamber, said outer surface of said chamber comprising an inlet for admitting gas to be pumped and an outlet for exhausting gas; and
a rotor housed within the chamber and configured to cooperate with the stator and the inlet portion during operation of the vacuum pump to pump gas from the inlet to the outlet,
wherein the inlet portion is mounted within an inlet channel of the vacuum pump and defines at least a portion of the inlet, and
wherein a surface of the inlet portion facing the chamber forms a portion of the outer surface of the chamber.

2. The vacuum pump according to claim 1, wherein the inlet portion is made from a plastics material.

3. The vacuum pump according to claim 1, wherein the inlet portion comprises a valve support and the vacuum pump comprises a valve member supported by the valve support, the valve member being movable between an open position permitting gas flow through the inlet channel and a closed position inhibiting gas flow through the inlet channel.

4. The vacuum pump according to claim 3, further comprising an inlet cover at least partly defining the inlet channel, wherein the inlet cover comprises a valve seat, wherein the valve member, in the closed position, is configured to seal against the valve seat.

5. The vacuum pump according to claim 4, wherein the inlet cover comprises:
an upstream portion configured for coupling to an enclosure to be evacuated; and
a downstream portion for connection to the stator;
wherein a portion of the inlet channel defined by the upstream portion and a portion of the inlet channel defined by the downstream portion are offset with respect to each other to form a kinked inlet channel;
wherein the inlet cover further comprises a protrusion extending into the inlet channel and configured to impede fluid from travelling from the chamber through the inlet channel towards the upstream portion of the inlet cover.

6. The vacuum pump according to claim 3, wherein the valve member comprises an O-ring for sealing against the valve seat.

7. The vacuum pump according to claim 3, wherein the valve member is formed from a plastics material.

8. The vacuum pump according to claim 3, wherein the inlet portion comprises a gas channel for conveying gas to selectively actuate the valve member from the open position to the closed position.

9. The vacuum pump according to claim 3, wherein the inlet cover and the inlet portion are arranged such that, during operation of the vacuum pump, gas flows through the inlet channel, around the inlet portion and into the chamber.

10. The vacuum pump according to claim 1, wherein the portion of the outer surface of the chamber defined by the stator is made of metal.

11. The vacuum pump according to claim 1, wherein the surface of the inlet portion facing the chamber is curved.

12. The vacuum pump according to claim 11, wherein a curvature of the surface matches a curvature of the portion of the outer surface of the chamber defined by the stator.

13. The vacuum pump according to claim 1, wherein the inlet portion is mounted such that the rotor does not contact the surface of the inlet portion facing the chamber during operation of the vacuum pump.

14. The vacuum pump according to claim 1, wherein the surface of the inlet portion defines at least 5%, preferably at least 10%, of a circumference of a cross-section of the outer surface of the chamber.

15. The vacuum pump according to claim 1, comprising an oil-sealed vacuum pump.

16. A method of replacing an inlet valve of a rotary vane vacuum pump, comprising at least one of the following:
a. removing the inlet portion from a rotary vane vacuum pump according to any preceding claim and inserting a replacement inlet portion;
b. removing a valve member from a rotary vane vacuum pump according to claim 3, and inserting a replacement valve member.
